(19) United States
(12) Patent Application Publication
(10) Pub. No.: US 2017/0233992 A1
(43) Pub. Date: Aug. 17, 2017

(54) FLUSHING DEVICE

(71) Applicant: GEBERIT INTERNATIONAL AG, Jona (CH)

(72) Inventor: Roland OBERHOLZER, Uster (CH)

(73) Assignee: GEBERIT INTERNATIONAL AG, Jona (CH)

(21) Appl. No.: 15/502,887

(22) PCT Filed: Aug. 6, 2015
(86) PCT No.: PCT/EP2015/068168

§ 371 Date: Feb. 9, 2017

(30) Foreign Application Priority Data
Aug. 20, 2014 (EP) 14181563.9

(51) Int. Cl. E03D 5/10; F16K 31/00; G01K 13/02; E03D 13/00

(52) U.S. Cl. CPC E03D 5/105; E03D 13/00; F16K 31/002; G01K 13/02

(57) ABSTRACT

A flushing device (1) for a sanitary article (2), in particular a urinal or a toilet, said flushing device comprising a control unit (3), and a flushing valve (4) that can be controlled by means of the control unit (3) for controlling a flushing procedure, wherein a fluid for flushing or for cleaning the sanitary article (2) is introduced during a flushing procedure, wherein it is possible by means of the control unit (3) to predetermine a flushing regime for the flush activation. The control unit (3) further comprises a temperature sensor (5) for detecting the ambient temperature (T), wherein the temperature sensor (5) is connected by way of a data channel (7) to the control unit (3) and wherein the flushing regime can be adjusted on the basis of the ambient temperature (T).

### TECHNICAL FIELD

The present invention relates to a flushing device according to the preamble of claim 1.

### PRIOR ART

A variety of ways of controlling the flushing procedure for flushing urinals or toilets are known in the prior art.

An interval control process that activates a flushing procedure at predefined intervals is frequently used particularly in public toilets. A predefined interval can be by way of example 1 hour. In addition, flushing regimes are known in which after a first use the control process waits for a predefined period of time before it activates a further flushing procedure.

Similarly, flushing regimes of this type are used in waterless urinals, wherein a cleaning solution is used at predefined intervals in lieu of flushing water. The cleaning solution is discharged onto the inner face of the urinal.

A disadvantage of the prior art is the fact that the flushing procedures are performed according to a fixed pattern which leads to an inefficient use of the flushing water or of the cleaning agent.

### SUMMARY OF THE INVENTION

Based on this prior art, it is an object of the invention to provide a control device for urinals and/or toilets, wherein the control device is to overcome the disadvantages of the prior art. In particular, it is an object of the invention to provide a control device that provides a cleaning procedure or a flushing procedure with respect to aspects of hygiene whilst observing the most efficient use of water or cleaning agent.

The subject matter of claim 1 achieves this object. Accordingly, a flushing device for a sanitary article comprises a control unit and a flushing valve that is controllable by means of the control unit so as to control a flushing procedure. The sanitary article is preferably a urinal or a toilet. A fluid for flushing or cleaning the sanitary article is introduced during a flushing procedure. The fluid flows thereby into the sanitary article. It is possible by means of the control unit to predefine a flushing regime for activating the flushing procedure and the flushing procedure is performed according to said flushing regime. Furthermore, the control unit comprises a temperature sensor for detecting the prevailing ambient temperature around the sanitary article, wherein the temperature sensor is in connection by way of a data channel with the control unit and wherein the flushing regime is adjustable according to the ambient temperature.

The flushing regime is therefore based on the temperature that is prevailing around the sanitary article. In particular, the fluid is thereby delivered on the basis of the ambient temperature. The temperature sensor provides a temperature signal or temperature data as an input variable to the control unit by way of the data channel.

As a result of detecting the ambient temperature around the sanitary article, it is possible to adjust the flushing regime in an efficient manner. If the ambient temperature increases by way of example towards 30° C., the bacteria in the urine start to multiply rapidly and an unpleasant smell is produced. At these temperatures, a conventional flushing interval is not able to sufficiently meet the requirements with respect to hygiene. In this respect, it is possible as a result of detecting the ambient temperature to adjust the flushing regime to such an extent that the hygiene requirements are still fulfilled whilst delivering an advantageous amount of fluid.

The control unit preferably comprises a timer. The flushing regime is thereby configured in such a manner that it is possible to activate a flushing procedure after a time interval. This time interval can be adjusted when adjusting the flushing regime.

In other words: the flushing regime is preferably configured in such a manner that the flushing procedure is activated in a time-controlled manner after a time interval, wherein this time interval changes based on the temperature that is measured by the temperature sensor. As a consequence, this flushing regime is a time-controlled interval control that is initiated irrespective of the use of the sanitary article. The time interval can be adjusted according to the above described adjustments.

In an alternative, the control unit comprises a timer and a detection element for detecting the use of the flushing device, wherein the flushing regime is configured in such a manner that after it is detected that the sanitary article has been used, a time interval commences to run and a flushing procedure is activated after this time interval has expired. This time interval can be adjusted when adjusting the flushing regime.

In other words: The flushing regime is configured in accordance with the alternative in such a manner that the flushing procedure is activated after a time interval that commences to run in the case of the sanitary article being used. Consequently, this flushing regime is an interval-controlled regime that initiates the flushing procedure in dependence upon the use of the sanitary article. In other words, the flushing procedure is activated after a time interval has elapsed, said time interval being measured from a use of the sanitary article. The time interval can be adjusted according to the above described adjustments. The control unit comprises for this flushing regime the said timer and the said detection element.

In the case of all the embodiments, the timer and where applicable the detection element are in connection with the control unit or are part of said control unit.

The time interval is preferably 1 hour, 2 hours, 3 hours, 4 hours, 5 hours, 6 hours, 7 hours, 8 hours, 9 hours, 10 hours, 11 hours or 12 hours.

In a first embodiment of adjusting the flushing regime, the interval period between two flushing procedures can be reduced as the ambient temperature increases. The time interval between two flushing procedures can be increased as the ambient temperature reduces or drops back. Consequently, it is possible to create a flushing regime that uses the fluid in a very efficient manner, in that the interval period between two flushing procedures during which the fluid is delivered to the sanitary article is reduced. This first embodiment involves a dynamic adjustment of the flushing regime.

In a second embodiment of adjusting the flushing regime, the interval period between two flushing procedures can be reduced if the ambient temperature exceeds a threshold value and the interval period between two flushing procedures can be increased if the ambient temperature is below a threshold value. The threshold value is preferably in the range from 25° C. to 30° C., in particular between 25° C. and 27° C. Alternatively, the threshold value is greater than 25° C. The second embodiment involves a static adjustment of the flushing regime.

In a third embodiment of adjusting the flushing regime, if the ambient temperature is rising, the switching cycle of the flushing valve can be increased, as a result of which a greater quantity of fluid can be delivered per flushing procedure. Furthermore, if the ambient temperature is reducing, the switching cycle of the flushing valve can be reduced, as a result of which a smaller quantity of fluid can be delivered per flushing procedure.

In a fourth embodiment of adjusting the flushing regime, if the ambient temperature exceeds a threshold value, the switching cycle of the flushing valve can be increased, as a result of which a greater quantity of fluid can be delivered per flushing cycle, and if the ambient temperature is below a threshold value, the switching cycle of the flushing valve can be reduced, as a result of which a smaller quantity of fluid is delivered per flushing procedure. It is preferred that the limit value is in the range from 25° C. to 30° C., in particular between 25° C. and 27° C., or is greater than 25° C.

The third or fourth embodiment can be combined with the first two embodiments, wherein both the interval period and also the switching cycle are adjusted or are used in a stand-alone arrangement as an adjustment.

In a further embodiment, if a predefined threshold value is exceeded, a separate flushing procedure is activated, wherein it is preferred that the predetermined threshold value is in the range from 25° C. to 30° C., in particular between 25° C. and 27° C., or wherein the threshold value is greater than 25° C. After the separate flushing procedure, the flushing regime can be adjusted in accordance with one of the above described embodiments.

It is preferred that the temperature sensor is arranged in the region of the control unit. It is particularly preferred that the temperature sensor together with the control unit and the flushing valve are arranged at or on a supporting element that can be connected to the sanitary article. The supporting element is embodied with connection sites for connection to the sanitary article. In this variant, the temperature sensor is part of the sanitary article.

In another variant, the temperature sensor is arranged spaced apart from the sanitary article or control unit. By way of example, the temperature sensor is mounted in the region of a wall. Alternatively, the temperature sensor can also be placed in the region of an inspection opening that provides access to a flushing cistern or similar.

It is particularly preferred to position the temperature sensor as close as possible to the sanitary article, it is particularly preferred to integrate the temperature sensor in the control unit. Insofar as the temperature sensor is positioned spaced apart from the control unit, then the spacing between the control unit and the temperature sensor is preferably greater than 0.3 meter, in particular greater than 0.5 meter, particularly preferred greater than 1 meter.

The data channel between the temperature sensor and the control unit is preferably a wire-connected or wireless data channel. The values measured by means of the temperature sensor are transmitted by way of the said data channel from the temperature sensor to the control unit. The control unit comprises corresponding elements so as to receive, store and process the data.

A sanitary article arrangement comprises a sanitary article and a flushing device according to the above description, wherein the temperature sensor is arranged outside the fluid-carrying surfaces of the sanitary article. The term ‘fluid-carrying surfaces’ is understood to mean all surfaces of the sanitary article arrangement that come into contact with the fluid for flushing or cleaning purposes and/or with urine during use of said sanitary article arrangement. The temperature sensor is therefore arranged in such a manner that said temperature sensor does not come into contact with the fluid or urine. Therefore, it is not the temperature of the fluid or of the urine that is measured but rather exclusively the air temperature of the environment. This process prevents an inaccurate measurement.

The sanitary article preferably comprises a receiving device for the temperature sensor. The receiving device is preferably positioned below or spaced apart from the water-carrying surfaces of the sanitary article. In other words, the temperature sensor is arranged in such a manner that said temperature sensor does not come into contact with the water-carrying surface of the sanitary article. The control unit is likewise connected to the sanitary article.

Alternatively, the temperature sensor is arranged spaced apart from the sanitary article and the control unit is in connection with the sanitary article.

The temperature sensor and the control unit are in connection by way of the said wire-connected or wireless communication channel.

In a further development, the sanitary article comprises preferably a bowl having a surface. The bowl is used to receive the excretions during use. Furthermore, the sanitary article comprises a hollow chamber that is accessible by way of an inspection opening. The hollow chamber does not come into contact with the fluid or the excretions. The control unit is preferably arranged at least in part in the said hollow chamber. The temperature sensor can protrude from the hollow chamber out of the inspection opening or can be arranged in the hollow chamber. In the latter case, the hollow chamber is preferably designed in such a manner that the surrounding air can flow easily into the hollow chamber. The temperature sensor can, however, also be arranged spaced apart from the control unit, wherein it is not placed in the hollow chamber.

In one variant, the sanitary article is connected to a water conduit, wherein the flushing valve controls the delivery of the fluid from the water conduit. In an alternative variant, the sanitary article comprises a flushing cistern in which flushing water is stored, wherein the flushing valve controls the delivery of fluid from the flushing cistern. In a further alternative variant, the sanitary article comprises a tank in which a cleaning fluid is stored as said fluid, wherein the flushing valve controls the delivery of the cleaning fluid.

The sanitary article can therefore be designed in such a manner that it is flushed using water or that water is not involved. In the case of the waterless variant, the sanitary article is preferably designed as a urinal and is cleaned using a cleaning fluid.

A method for controlling a flushing device according to the above description is characterized by virtue of the fact that the environment temperature is detected by means of the temperature sensor and a temperature signal corresponding to the temperature is generated, that the temperature signal is transmitted to the control unit by way of the data channel, and that the flushing regime is adjusted with reference to the temperature signal.

The flushing regime is adjusted during the said step as described above.

It is preferred that the time interval is adjusted during the step of adjusting the control process. As an alternative or in addition thereto, a separate flushing procedure is activated during the step of adjusting the control process.

Further embodiments are disclosed in the dependent claims.

### BRIEF DESCRIPTION OF THE DRAWINGS

Preferred embodiments or the invention are described hereinunder with reference to the drawings that are used merely for explanation purposes and are not to be considered as limiting. In the drawings:

FIG. 1 illustrates a schematic view of a sanitary article arrangement having a flushing device according to a first embodiment;

FIG. 2 illustrates a schematic view of a sanitary article arrangement having a flushing device according to a second embodiment;

FIG. 3 illustrates a sectional view through a sanitary article having a flushing device in accordance with the invention;

FIG. 4a/b illustrates a schematic illustration of a possible first flushing regime having the flushing device in accordance with the invention; and

FIG. 5a/b illustrates a schematic illustration of a possible second flushing regime having the flushing device in accordance with the invention.

### DESCRIPTION OF PREFERRED EMBODIMENTS

The figures illustrate different elements of a flushing device 1 in accordance with the invention for a sanitary article 2. The sanitary article 2 is preferably a urinal or a toilet.

In principle, the flushing device 1 comprises a control unit 3 and a flushing valve 4 that can be controlled by means of the control unit 3 for controlling a flushing procedure. A fluid for flushing or cleaning the sanitary article is introduced during the flushing procedure. The fluid can be by way of example water, wherein the term ‘water flush’ is used. However, the fluid can also be a cleaning agent that is periodically delivered to the sanitary article. In the latter case, the sanitary article can be described as a waterless-flushed sanitary article. A flushing regime for the activation of the flushing procedure can be predetermined or defined by means of the control unit 3. In other words, the flushing valve 4 is opened and closed according to the flushing regime so that the fluid is delivered to the sanitary article 2 during the flushing procedure.

Furthermore, the control unit 3 comprises a temperature sensor 5 for detecting the ambient temperature T. The ambient temperature T is the air temperature that is prevailing in the chamber 16 in which the sanitary article 2 is mounted. The temperature sensor 5 is in connection by way of a data channel 7 with the control unit 3. Signals or data regarding the measured ambient temperature T can be transmitted by way of the data channel 7 from the temperature sensor 5 to the control unit 3. The flushing regime that can be predetermined by means of the control unit 3 can be adjusted on the basis of the ambient temperature T. As a result of adjusting the flushing regime, it is possible, under the proviso that the flushing procedure is to be performed using as little fluid as possible, for the flushing regime to be optimized with respect to aspects of hygiene.

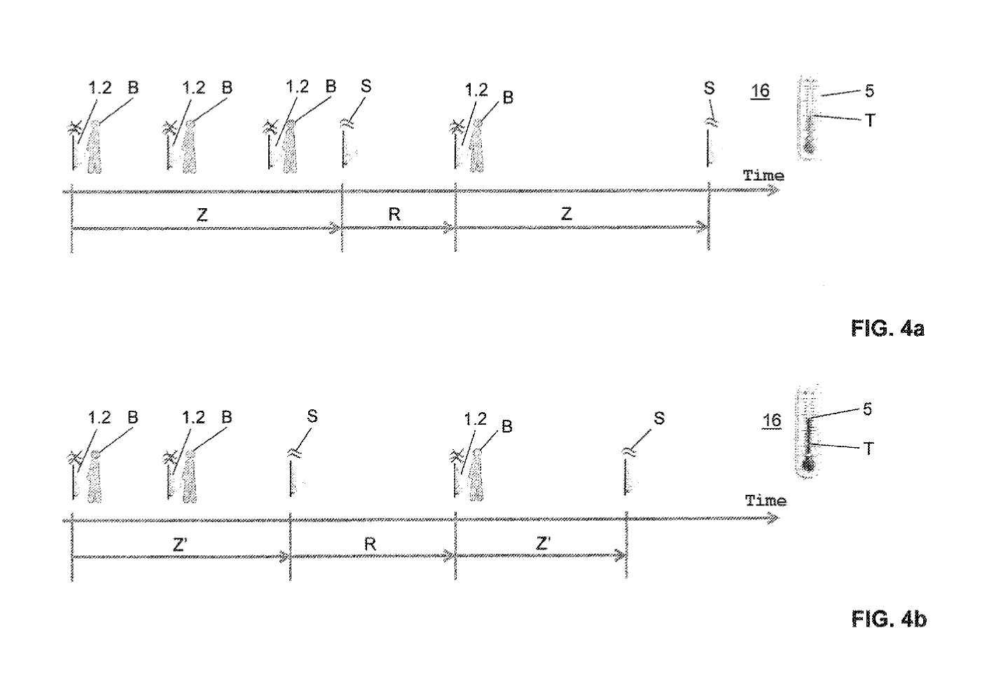

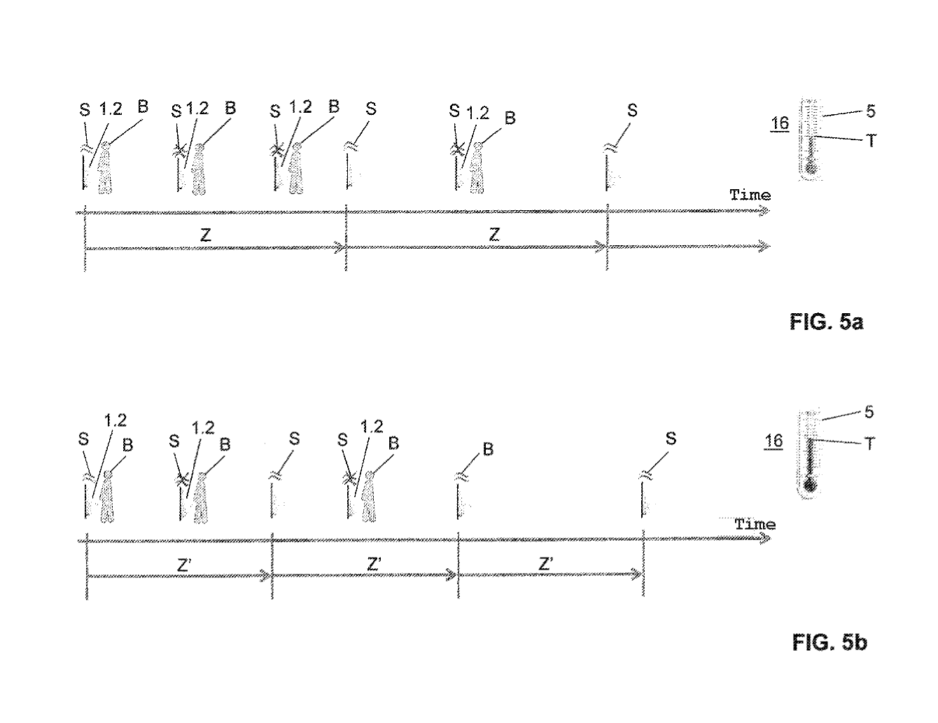

The flushing regime can be adjusted in numerous ways and can include the adjustment of different parameters. By way of example, one possible adjustment of the flushing regime is to adjust the time interval between two flushing procedures on the basis of the ambient temperature T. Furthermore, the quantity of delivered fluid can also be adjusted on the basis of the ambient temperature T. In this case, by way of example, a new switching cycle of the flushing valve would be predetermined accordingly. Two particularly preferred flushing regimes are explained in detail hereinunder with reference to the FIGS. 4a to 5b.

Essentially, three variants are feasible regarding the arrangement of the temperature sensor 5 with respect to the control unit 3 or the sanitary article 2.

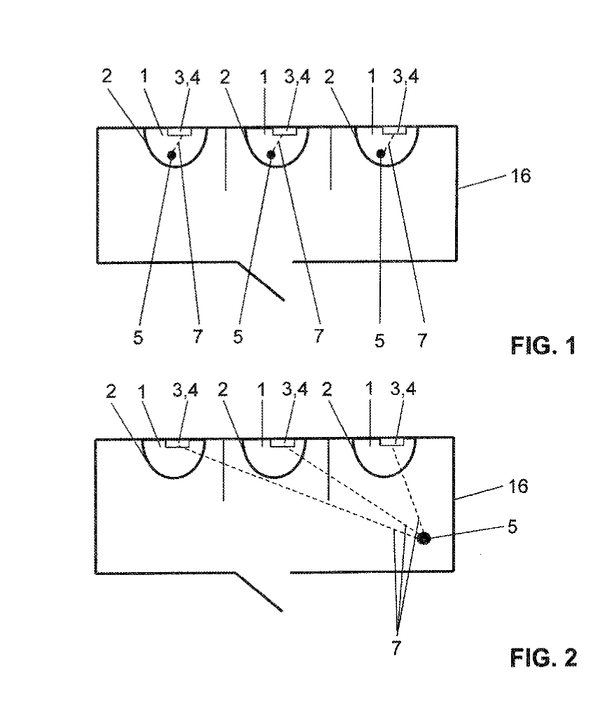

The first variant is illustrated in FIG. 1. In accordance with this variant, the temperature sensor 5 for detecting the ambient temperature T is arranged in the region of the control unit 3. In other words, the temperature sensor 5 is arranged adjacent to the control unit 3 or integrated in the control unit 3. It is particularly preferred to arrange the temperature sensor 5 together with the control unit 3 and the flushing valve 4 on a supporting element 6 that can be connected to the sanitary article 2. In the first variant, the temperature sensor 5 is arranged in such a manner that said temperature sensor does not come into contact with the water-carrying surfaces of the sanitary article 2. The temperature sensor 5 is therefore arranged in such a manner that said temperature sensor does not measure the temperature of the urine or of the fluid but rather essentially only measures the air temperature of the surrounding air. The temperature sensor 5 is in connection by means of a data channel 7 with the control unit 3. The data channel 7 in this embodiment is preferably a wire-connected data channel. However, it can also be a wireless data channel.

In the second variant that is illustrated in FIG. 2, the temperature sensor 5 is arranged spaced apart at a spacing A or remote from the sanitary article 2 or the control unit 3. It is feasible by way of example to arrange the temperature sensor 5 in the region of a wall or an inspection opening. In the illustrated embodiment of FIG. 2, only a single temperature sensor 5 is provided in the chamber 16. This one temperature sensor 5 is connected by way of a respective data channel 7 to one or multiple control units 3 of the sanitary article 2. For the embodiment illustrated in FIG. 2, a single temperature sensor 5 is connected to three control units 3 of three sanitary articles 2. It is thereby preferred that the data channel 7 between the temperature sensor 5 and the multiple control units 3 is a wireless data channel 7. The data channel 7 can also be a wire-connected data channel. The spacing A between the control unit 3 and the temperature sensor 5 is preferably greater than 0.3 m, in particular greater than 0.5 m, particularly preferred greater than 1 m. The maximum spacing depends essentially upon the design of the data channel 7. However, it is advantageous with regard to the reliability of the measurement results provided by the temperature sensor 5 with regard to the temperature distribution in the chamber 16, if the maximum spacing is not greater than 10 m or 20 m.

In an alternative third variant that is not illustrated in the figures, the control unit 3 is likewise arranged centrally. A single control unit 3 is connected to multiple sanitary articles and activates the flushing procedure for each one of the sanitary articles. In this embodiment, the control unit 3 comprises a single flushing valve that controls the delivery of flushing fluid to all the sanitary articles. The control unit 3 comprises as in the other embodiments a temperature sensor for detecting the ambient temperature. It is possible to state with regard to FIG. 2 that the control unit 3 is positioned with the flushing valve in the region of the temperature sensor 5 as illustrated there.

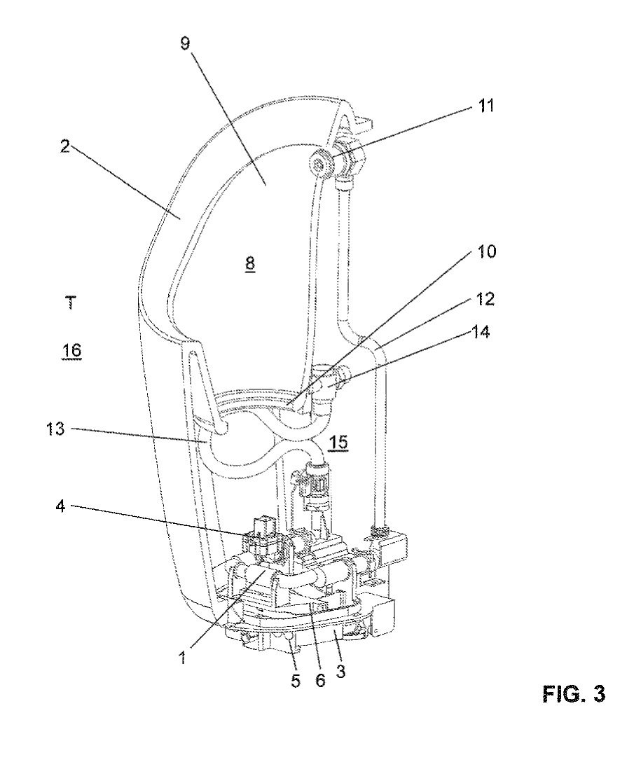

FIG. 3 illustrates a sectional view in accordance with a possible embodiment of a sanitary article 2. The sanitary article 2 is illustrated here as a urinal.

The urinal comprises in the illustrated embodiment a urinal bowl 9 that issues into a urinal drain 10. The urinal drain 10 is connected to an outflow device that is not illustrated here. The outflow device is connected to a waste water system. It is preferred that the outflow device comprises an odour seal, such as a siphon or a sealing membrane.

A nozzle head 11 is arranged in the upper region of the urinal bowl 9 and fluid can be delivered to the urinal bowl 9 by way of said nozzle head. The nozzle head 11 is in connection with the flushing valve 4 by way of a feed conduit 12. The flushing valve 4 is in connection in turn by way of a further conduit 13 with a water connection 14. As soon as the flushing valve is opened, the flushing water can pass from the water connection through the further conduit 13 to the nozzle head 11 by way of the flushing valve 4 and the feed conduit 12. The urinal bowl 9 is flushed accordingly from there.

The flushing valve 4 is arranged in this case together with the control unit 3 on a supporting element 6. The supporting element 6 is a mechanical carrier by way of which the control unit 3 and the flushing valve 4 are fastened to the sanitary article 2. Furthermore, the temperature sensor 5 is arranged on the supporting element 6. The temperature sensor 5 is in connection, as already described above, by way of a data channel with the control unit 3. The temperature sensor 5 is arranged in this case on the lower face opposite the control unit 3 and the flushing valve 4 on the supporting element 6. It is particularly preferred that the supporting element 6 is configured with regard to the sanitary article 2 in such a manner that the temperature sensor 5 is positioned below the sanitary article 2 in the installed state and consequently air can flow freely over said temperature sensor.

Alternatively, the temperature sensor 5 can also be arranged below the hollow chamber 15 of the urinal bowl 9. In comparison to the arrangement illustrated in FIG. 3 in which the temperature sensor 5 is positioned outside the hollow chamber 15, the hollow chamber 15 is to be made accessible so that the ambient air is efficiently directed to the temperature sensor 5. Otherwise, the measured temperature in the hollow chamber 15 must be corrected accordingly. The arrangement within the hollow chamber 15 has the advantage that it is possible to increase the protection against vandalism.

It is preferred that the temperature sensor 5 is arranged in all embodiments in such a manner that said temperature sensor is arranged outside the water-carrying surface 8 of the sanitary article 2. The water-carrying surface 8 is essentially the surface of the urinal bowl 9 and also the surfaces of the outflow device. These surfaces come into contact with the urine and the fluid. The temperature sensor 5 therefore does not come into contact with the urine or the flushing fluid.

It is also possible to configure the sanitary article arrangement differently in lieu of the feed conduit 12, the conduit 13 and the water connection 14. By way of example, it is feasible that a flushing cistern is provided in lieu of the water conduit, wherein the flushing cistern is in connection by way of the conduit 13 with the feed conduit 12. Alternatively, it is also possible to provide a tank in which a cleaning fluid is stored, wherein the flushing valve correspondingly controls the access to the cleaning valve.

A flushing regime according to one embodiment is illustrated in FIGS. 4a and 4b. FIG. 4a illustrates the flushing regime in the case of a normal ambient temperature and FIG. 4b illustrates the flushing regime in the case of an increased ambient temperature. The sanitary articles 2 that are illustrated in FIGS. 4a and 4b are configured in accordance with the above description.

With regard to FIG. 4a: as soon as a user B uses the sanitary arrangement 1, an interval period Z commences to run. A flushing procedure S is activated after the interval period Z has ended. The reference letter S indicates that the flushing procedure is activated. The flushing procedure is not performed during the interval period, in other words, the flushing procedure S is activated irrespective of the number of times the sanitary article arrangement is used. An idle period R subsequently follows the flush activation. The interval period Z does not run during this idle period R. Following a further use of the sanitary article arrangement, illustrated in FIG. 4a at the end of the idle period R, the interval period Z commences in turn to run and a new flushing procedure is activated.

With regard to FIG. 4b: if the temperature of the surrounding air in the chamber increases, this increase is detected by means of the temperature sensor 5 and the flushing regime is adjusted accordingly. In the illustrated embodiment, the interval period Z is reduced accordingly. Following the use of the sanitary article arrangement, a reduced interval period Z′ runs until a flushing procedure S is activated. There then follows an idle period R until further use of the sanitary article arrangement occurs. Following this further use of the sanitary article arrangement, a reduced interval period Z′ runs in turn until a further flushing procedure S is performed. The interval period Z is therefore reduced.

If the ambient temperature reduces in the region of the sanitary article arrangement, the interval period is increased as is illustrated in FIG. 4a.

For the flushing regime according to this embodiment, the control unit 3 comprises a timer for specifying the interval period Z and a detection element for detecting the usage of the flushing device. The flushing valve 4 is controlled based on the timer Z.

A flushing regime according to a further embodiment is illustrated in FIGS. 5a and 5b. FIG. 5a illustrates the flushing regime in the case of a normal ambient temperature and FIG. 5b illustrates the flushing regime in the case of an increased ambient temperature. The sanitary articles 2 that are illustrated in FIGS. 5a and 5b are configured in accordance with the above description.

With regard to FIG. 5a: A flushing procedure S is activated at the end of the interval period Z. The flush activation is indicated by the reference letter S. A flushing procedure is not performed during the interval period, in other words, the flushing procedure S is activated irrespective of the number of times the sanitary article arrangement is used. The next interval period Z commences to run immediately after the first interval period Z has ended, wherein a flushing procedure S is activated in turn after said next interval period Z has ended.

With regard to FIG. 5b: if the temperature of the ambient air in the chamber increases, this increase is detected by means of the temperature sensor 5 and the flushing regime is adjusted accordingly. In the illustrated embodiment, the interval period Z is reduced accordingly. The reduced interval period is represented by the reference letter Z′.

If the ambient temperature reduces in the region of the sanitary article arrangement, the interval period is increased as is illustrated in FIG. 5a.

For the flushing regime according to this embodiment, the control unit 3 comprises a timer, wherein the flushing regime is configured in such a manner that a flushing procedure can be activated after a fixed interval period has ended.

Irrespective of the implementation of the flushing regime, two different types of adjusting the flushing regime are feasible with regard to the ambient temperature, namely a dynamic adjustment and a static adjustment.

In the case of the dynamic adjustment, the interval period Z between two flushing procedures is reduced in the case of an increasing ambient temperature T. The interval period Z between two flushing procedures is increased in the case of a reducing ambient temperature T. The change in the interval period can be performed in a linear manner with respect to the change in the ambient temperature T.

In the case of the static adjustment of the flushing regime, the interval period Z between two flushing procedures is reduced if the ambient temperature T exceeds a fixed threshold value. The interval period Z is then increased if said ambient temperature is below said threshold value. It is preferred that the threshold value is in the range of 25 to 30° C., in particular between 25° and 27° C. It is particular preferred that the threshold value is greater than 25° C.

Irrespective of the implementation of the flushing regime and the adjustment of said flushing regime, it is possible to activate a separate flushing procedure in the case of a predefined threshold value being exceeded. It is preferred that the threshold value is in the range of 25 to 30° C., in particular between 25° and 27° C. It is particularly preferred that the threshold value is greater than 25° C.

### LIST OF REFERENCE SIGNS

1 Flushing device

2 Sanitary article

3 Control unit

4 Flushing valve

5 Temperature sensor

6 Supporting element

7 Data channel

8 Water-carrying surface

9 Urinal bowl

10 Urinal drain

11 Nozzle head

12 Feed conduit

13 Further conduit

14 Water connection

15 Hollow chamber

16 Chamber

R Idle period

S Flush activation

T Ambient temperature

Z Interval period

Z′ Reduced interval period

1. A flushing device for a sanitary article, said flushing device comprising:
a control unit, and
a flushing valve that is controllable by means of the control unit for controlling a flushing procedure, wherein a fluid for flushing or for cleaning the sanitary article is introduced during a flushing procedure,
wherein it is possible by means of the control unit to predetermine a flushing regime for the flush activation,
wherein the control unit further comprises a temperature sensor for detecting the ambient temperature, wherein the temperature sensor is in connection by way of a data channel with the control unit and wherein the flushing regime is adjustable on the basis of the ambient temperature.

2. The flushing device according to claim 1, wherein the control unit comprises a timer, wherein the flushing regime is configured in such a manner that a flushing procedure can be activated after an interval period has ended, wherein this interval period is changeable based on the ambient temperature that is measured by the temperature sensor.

3. The flushing device according to claim 1, wherein the control unit comprises a timer and a detection element for detecting the use of the flushing device, wherein the flushing regime is configured in such a manner that an interval period commences to run after it is detected that the sanitary article has been used and a flushing procedure is activatable after this interval period has ended, wherein this interval period is changeable based on the ambient temperature that is measured by the temperature sensor.

4. The flushing device according to claim 2, wherein the interval period between two flushing procedures can be reduced in the case of an increasing ambient temperature, and that the interval period between two flushing procedures can be increased in the case of a reducing ambient temperature.

5. The flushing device according to claim 2, wherein if the ambient temperature exceeds a threshold value, the interval period between two flushing procedures can be reduced, and wherein if the ambient temperature is below a threshold value, the interval period between two flushing procedures can be increased.

6. The flushing device according to claim 1, wherein the switching cycle of the flushing valve can be increased in the case of an increasing ambient temperature, whereby a greater quantity of fluid can be delivered per flushing procedure, and wherein the switching cycle of the flushing valve can be reduced in the case of a reducing ambient temperature, whereby a smaller quantity of fluid can be delivered per flushing procedure,
or wherein if the ambient temperature exceeds a threshold value, the switching cycle of the flushing valve can be increased, whereby a greater quantity of fluid can be delivered per flushing procedure, and if the ambient temperature is below a threshold value, the switching cycle of the flushing valve can be reduced, whereby a smaller quantity of the fluid can be delivered per flushing procedure.

7. The flushing device according to claim 1, wherein in the case of a predefined threshold value being exceeded, a separate flushing procedure can be activated.

8. The flushing device according to claim 1, wherein the temperature sensor is arranged in the region of the control unit.

9. The flushing device according to claim 1, wherein the temperature sensor is arranged spaced apart at a spacing from the sanitary article or control unit.

10. The flushing device according to claim 1, wherein the data channel between the temperature sensor and the control unit is a wire-connected or wireless data channel.

11. A sanitary article arrangement comprising a sanitary article and a flushing device according to claim 1, wherein the temperature sensor is arranged outside the water-carrying surface of the sanitary article.

12. The sanitary article arrangement according to claim 11, wherein the sanitary article comprises a reception for the temperature sensor, or wherein the temperature sensor is arranged spaced apart at a spacing from the sanitary article and wherein the control unit is in connection with the sanitary article.

13. The sanitary article arrangement according to claim 11, wherein the sanitary article is connected to a water conduit, wherein the flushing valve controls the delivery of the fluid from the water conduit, or wherein the sanitary article comprises a flushing cistern in which flushing water is stored, wherein the flushing valve controls the delivery of the fluid from the flushing cistern, or wherein the sanitary article comprises a tank in which a cleaning fluid is stored, wherein the flushing valve controls the delivery of the cleaning fluid.

14. A method for controlling a flushing device according to claim 1,
wherein the ambient temperature is detected by means of the temperature sensor and a temperature signal that corresponds to the temperature is generated,
wherein the temperature signal of the control unit is provided by way of the data channel, and
wherein the flushing regime is adjusted on the basis of the temperature signal.

15. The method according to claim 14, wherein at least one of the interval period is adjusted during the step of adjusting the control process and a separate flushing procedure is activated during the step of adjusting the control process.

16. The flushing device according to claim 1, wherein the sanitary article is a urinal or a toilet.

17. The flushing device according to claim 5, wherein the threshold value is in the range from 25° C. to 30° C.

18. The flushing device according to claim 5, wherein the threshold value is between 25° C. and 27° C.

19. The flushing device according to claim 5, wherein the threshold value is greater than 25° C.

20. The flushing device according to claim 6, wherein the threshold value is in the range from 25° C. to 30° C.

21. The flushing device according to claim 6, wherein the threshold value is between 25° C. and 27° C.

22. The flushing device according to claim 6, wherein the threshold value is greater than 25° C.

23. The flushing device according to claim 7, wherein the predefined threshold value is in the range from 25° C. to 30° C.

24. The flushing device according to claim 7, wherein the predefined threshold value is between 25° C. and 27° C.

25. The flushing device according to claim 7, wherein the threshold value is greater than 25° C.

26. The flushing device according to claim 8, wherein the temperature sensor is arranged together with the control unit and the flushing valve on a supporting element that can be connected to the sanitary article.

27. The flushing device according to claim 9, wherein the spacing between the control unit and the temperature sensor is greater than 0.3 meter.

28. The flushing device according to claim 9, wherein the spacing between the control unit and the temperature sensor is greater than 0.5 meter.

29. The flushing device according to claim 9, wherein the spacing between the control unit and the temperature sensor is greater than 1 meter.

30. The sanitary article arrangement according to claim 11, wherein the sanitary article is a urinal or a toilet.

31. The sanitary article arrangement according to claim 12, wherein the reception is positioned below the water-carrying surfaces of the sanitary article.

32. The flushing device according to claim 1, wherein the control unit comprises a timer and a detection element for detecting the use of the flushing device, wherein the flushing regime is configured in such a manner that an interval period commences to run after it is detected that the sanitary article has been used and a flushing procedure is activatable after this interval period has ended, wherein this interval period is changeable based on the ambient temperature that is measured by the temperature sensor and wherein the interval period between two flushing procedures can be reduced in the case of an increasing ambient temperature, and that the interval period between two flushing procedures can be increased in the case of a reducing ambient temperature.
